(19) United States
(12) Patent Application Publication
(10) Pub. No.: US 2010/0246361 A1
(43) Pub. Date: Sep. 30, 2010

(54) METHOD FOR CONVERTING STANDARD DVDS INTO BLU-RAY FORMAT

(75) Inventors: Valentino Miazzo, Macherio (IT); Gregory Maertens, Cernusco Sul Naviglio (IT); Bob Saffari, San Carlos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Mozaik Multimedia, Inc., Redwood City, CA (US)

(21) Appl. No.: 12/644,501

(22) Filed: Dec. 22, 2009

Related U.S. Application Data
(60) Provisional application No. 61/141,614, filed on Dec. 30, 2008.

(51) Int. Cl. G11B 27/00

(52) U.S. Cl. 369/83; G9B/27

(57) ABSTRACT

In various embodiments, systems, methods, and computer-readable storage media are provided to repurpose DVD authored content allowing any movie experience, high definition video, high quality sound, and/or interactivity provided by the DVD authored content to be accessed via next generation optical disc players. In one embodiment, DVD authored content may be stored as-is on a Blu-ray Disc for playback on a Blu-ray Disc player. The Blu-ray Disc player can be configured to interpret DVD navigations information in the DVD authored content and/or reformat audio/video information in the DVD authored content allowing any movie experience, high definition video, high quality sound, and/or interactivity provided by the DVD authored content to be experienced by users.

### CROSS-REFERENCES TO RELATED APPLICATIONS

This Application claims priority to and the benefit of U.S. Provisional Application No. 61/141,614, filed Dec. 30, 2008 and entitled “METHOD FOR CONVERTING STANDARD DVDS INTO BLU-RAY FORMAT,” which is hereby incorporated by reference for all purposes.

### BACKGROUND OF THE INVENTION

Blu-ray Disc (also known as Blu-ray or BD) is an optical disc storage medium. Generally, BD has the same physical dimensions as standard Digital Versatile Discs (also know as Digital Video Discs or DVDs) and Compact Discs (CDs). The main uses of BD can include the storage of data, high-definition video, and games. BD may support storage capacities of around 25 GB per single layered and 50 GB per dual layered disc. Thus, a two-layer Blu-ray Disc can store approximately six times the capacity of a two-layer DVD, or ten times that of a single-layer DVD. The name Blu-ray Disc may be derived from the blue laser (violet-colored) used to read and write this type of disc. Because of the beam's shorter wavelength (about 405 nanometers), substantially more data can be stored on a Blu-ray Disc than on discs configured to be read by lasers having a longer wavelength, such as a red laser (about 650 nm) typically used for DVDs. Other optical storage mediums, such as HD-DVD, may incorporate such blue laser technology to achieve greater storage capacities than standard DVDs and CDs

BD and other high definition (HD) formats thus may bring various improvements to a movie experience, such as high definition video, high quality sound, and interactivity. Table 1 provides an overview of some differences between standard DVD and BD:

TABLE 1

| Feature | DVD | Blu-ray |
|---|---|---|
| Maximum native resolutions supported via HDMI | EDTV (480p) | HDTV (720p, 1080i, 1080p) |
| Disc capacity | 4.7GB (single layer) | 25GB (single layer) |
| | 8.5GB (dual layer) | 50GB (dual layer) |
| Video capacity (per dual-layer disc) | SD: approximately 3 hours | SD: approximately 23 hours |
| | | HD: 8.5 or 5.6 hours, depending on encoding |
| | | method |
| Copy protection/digital rights management | Macrovision, CSS | AACS, ICT, BD+, BD-ROM Mark |
| Region-coded discs and players | Yes | Yes |

As the home video format of choice changed from the Video Home System (VHS) format to DVD, many consumer's existing VHS tape collection were slowly rendered obsolete due to the physically incompatible difference in format. Nowadays, with the transition from standard DVDs to BD, or other HD formats, most consumer electronic players are capable of playing back individual standard DVDs. Some BD players also include upconverting DVD technology.

However, content owners and movie studios already have a lot of content which has been previously authored in the DVD format. Preparing, converting, or reformatting existing DVD authored content to BD can be a costly process involving the authoring, remastering, interactivity development, etc. to take advantage of BD's enhanced video, sound, and interactivity and give consumers a reason to purchase the content in BD format. Some studios may not have the budget to perform such a conversion or the expected return on investment (ROI) may not worth the cost.

Accordingly, what is desired are improved methods and apparatus for solving some of the problems related to distributing content using optical discs, some of which may be discussed herein. Additionally, what is desired are improved methods and apparatus for reducing some of the drawbacks related to distributing content using optical discs, some of which discussed may be discussed herein.

### BRIEF SUMMARY OF THE INVENTION

The following portion of this disclosure presents a simplified summary of one or more innovations, embodiments, and/or examples found within this disclosure for at least the purpose of providing a basic understanding of the subject matter. This summary does not attempt to provide an extensive overview of any particular embodiment or example. Additionally, this summary is not intended to identify key/critical elements of an embodiment or example or to delineate the scope of the subject matter of this disclosure. Accordingly, one purpose of this summary may be present some innovations, embodiments, and/or examples found within this disclosure in a simplified form as a prelude to a more detailed description presented later.

In various embodiments, systems, methods, and computer-readable storage media are provided to repurpose DVD authored content allowing any movie experience, high definition video, high quality sound, and/or interactivity provided by the DVD authored content to be accessed via next generation optical disc players. In one embodiment, DVD authored content may be stored as-is on a Blu-ray Disc for playback on a Blu-ray Disc player. The Blu-ray Disc player can be configured to interpret DVD navigations information in the DVD authored content and/or reformat audio/video information in the DVD authored content allowing any movie experience, high definition video, high quality sound, and/or interactivity provided by the DVD authored content to be experienced by users.

In some embodiment, one or more adaptation layers can be hosted a Blu-ray Disc player for accessing DVD authored content stored on a Blue-ray Disc. In one embodiment, an adaptation layer executed by a Blu-ray Disc player can interpret DVD navigation information of DVD authored content stored on a Blu-ray Disc. In another embodiment, an adaptation layer executed by a Blu-ray Disc player can receive audio and/or video information of DVD authored content stored on a Blu-ray Disc. The adaptation layer may format, convert, or transcode the received audio and/or video information into audio and/or video information suitable for playback by the Blu-ray Disc player.

In further embodiments, DVD navigation information may be interpreted offline for DVD authored content representing multiple standard DVDs before being stored to a Blu-ray Disc. In one embodiment, an adaptation layer executed by a Blu-ray Disc player can use the DVD navigation information to access the multiple DVDs as found on the Blu-ray Disc.

A further understanding of the nature of and equivalents to the subject matter of this disclosure (as well as any inherent or express advantages and improvements provided) should be realized in addition to the above section by reference to the remaining portions of this disclosure, any accompanying drawings, and the claims.

### BRIEF DESCRIPTION OF THE DRAWINGS

In order to reasonably describe and illustrate those innovations, embodiments, and/or examples found within this disclosure, reference may be made to one or more accompanying drawings. The additional details or examples used to describe the one or more accompanying drawings should not be considered as limitations to the scope of any of the claimed inventions, any of the presently described embodiments and/or examples, or the presently understood best mode of any innovations presented within this disclosure.

FIG. 1 is a block diagram of a system for playback of DVD authored content using a DVD player.

FIG. 2 is a block diagram of a system for playback using a Blu-ray Disc player of DVD authored content stored on a Blu-ray Disc in one embodiment according to the present invention.

FIG. 3 is a block diagram illustrating playback using the system of FIG. 2 of DVD authored content stored on a Blu-ray Disc in one embodiment according to the present invention.

FIG. 4 is a flowchart of a method for playback using a Blu-ray Disc player of DVD authored content stored on a Blu-ray Disc in one embodiment according to the present invention.

FIG. 5 is a block diagram of reformatting DVD authored content stored on a Blu-ray Disc for playback using a Blu-ray Disc player in one embodiment according to the present invention.

FIG. 6 is a block diagram illustrating navigation using a Blu-ray Disc player of multiple DVDs stored on a Blu-ray Disc in one embodiment according to the present invention.

FIG. 7 is a block diagram of a computer system, information processing device, or consumer electronic device that may incorporate an embodiment, be incorporated into an embodiment, or be used to practice any of the innovations, embodiments, and/or examples found within this disclosure.

### DETAILED DESCRIPTION OF THE INVENTION

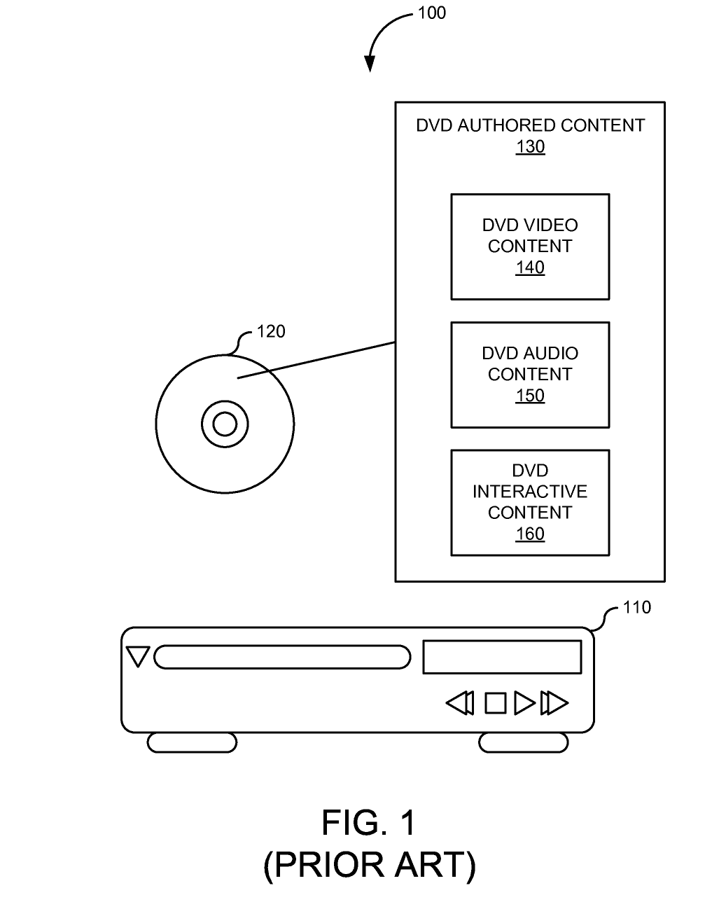

FIG. 1 is a block diagram of system 100 for playback of DVD authored content using DVD player 110. DVD player 110 can be embodied as a consumer electronic device, such as a stand-alone DVD player or portable DVD player. DVD player 110 can also be embodied as a personal computer having a DVD reader, a laptop, a notebook, or the like. In this example, DVD player 110 can be configured to read DVD 120. DVD 120 can be embodied as an optical disc that conforms to the DVD standard. DVD 120 may include (or have stored thereon) DVD authored content 130. DVD authored content 130 can include one or more various forms of content, such as DVD video content 140, DVD audio content 150, and DVD interactive content 160. Video, audio and subtitle streams can be multiplexed and stored on DVD 120 as DVD authored content 130 in the Video Object (VOB) container format.

DVD video content 140 may include digital video. The digital video may be encoded using MPEG-2 compression or MPEG-1 compression. The digital video may also include subtitle or subpicture tracks. DVD video content 140 may include one or more digital video streams, angles, chapters, or the like. DVD audio content 150 may include digital audio. The digital audio may be encoded using Pulse-code Modulation (PCM), Digital Theater System's Coherent Acoustics codec (DTS), MPEG-1 Audio Layer II (MP2), Dolby Digital (AC-3) format, or the like. DVD audio content 150 may include one or more digital audio streams, languages, effects, channels, or the like.

DVD interactive content 160 may include a wide variety of extra features in addition to DVD video content 140 and DVD audio content 150. DVD interactive content 160 may also be stored on DVD 120 separately from DVD video content 140 and DVD audio content 150. Interactive content can include audio commentary that is timed to a film sequence, documentary features, deleted scenes, photo galleries, storyboards, isolated music scores, trivia text commentary, games, film shorts, TV spots, radio spots and most commonly theatrical trailers, teaser trailers, or the like. Other extras that can be included DVD 120 can include motion menus, still pictures, selectable subtitles, seamless branching for multiple storylines, camera angles, and DVD-ROM/data files that can be accessed on a computer equipped with a DVD-ROM capable drive.

In various embodiments, systems, methods, and computer-readable storage media are provided to repurpose DVD authored content 130 allowing any movie experience, high definition video, high quality sound, and/or interactivity provided by DVD authored content 130 to be accessed via next generation optical disc players. In one embodiment, DVD authored content 130 may be stored as-is on a Blu-ray Disc for playback on a Blu-ray Disc player. The Blu-ray Disc player can be configured to interpret DVD navigations information in DVD authored content 130 and/or reformat audio/video information in DVD authored content 130 allowing any movie experience, high definition video, high quality sound, and/or interactivity provided by DVD authored content 130 to be experienced by users.

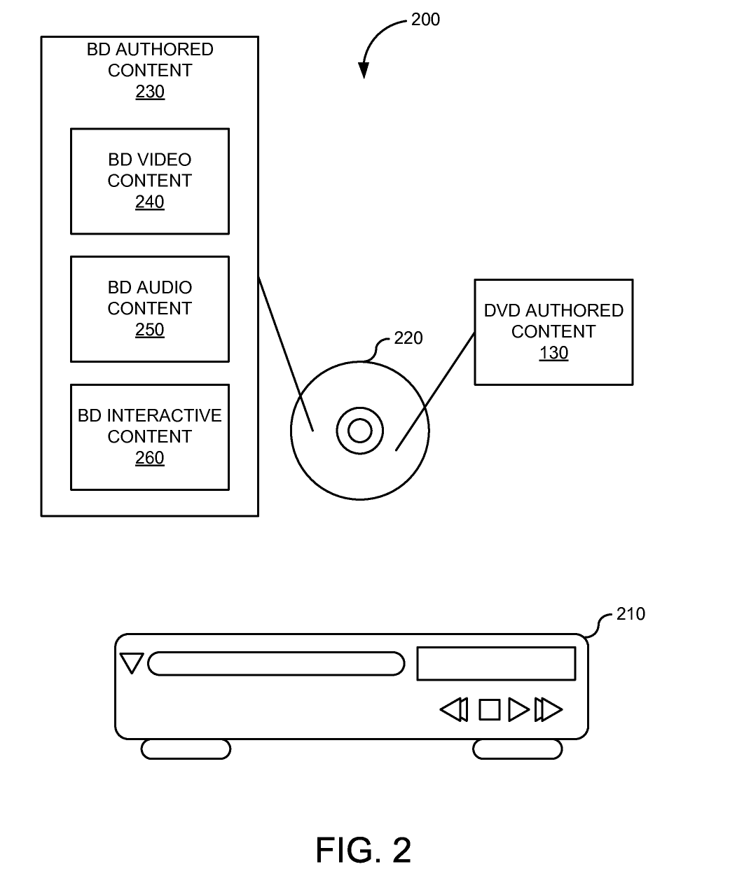

FIG. 2 is a block diagram of system 200 for playback using Blu-ray Disc player 210 of DVD authored content 130 stored on Blu-ray Disc (BD) 220 in one embodiment according to the present invention. Blu-ray Disc player 210 can be embodied as a consumer electronic device, such as a stand-alone Blu-ray Disc player or a portable Blu-ray Disc player. Blu-ray Disc player 210 can also be embodied as a personal computer having a Blu-ray Disc reader, a laptop, a notebook, or the like. In this example, Blu-ray Disc player 210 can be configured to read BD 220. BD 220 can be embodied as an optical disc that conforms to the Blu-ray standard. BD 220 may include (or have stored thereon) BD authored content 230. BD authored content 230 can include one or more various forms of content, such as BD video content 240, BD audio content 250, and BD interactive content 260. Video, audio and subtitle streams can be multiplexed and stored on BD 220 as BD authored content 230 in the Moving Pictures Expert Group (MPEG)-2 transport stream (M2TS) container format.

BD video content 240 may include digital video. The digital video may be encoded using MPEG-2 compression, MPEG-1 compression, H.264/MPEG-4 AVC, and SMPTE VC-1. The digital video may also include subtitle or subpicture tracks. BD video content 240 may include one or more digital video streams, angles, chapters, or the like. BD audio content 250 may include digital audio. The digital audio may be encoded using Pulse-code Modulation (PCM), Digital Theater System's Coherent Acoustics codec (DTS), MPEG-1 Audio Layer II (MP2), Dolby Digital (AC-3) format, or the like. BD audio content 250 may optionally support Dolby Digital Plus and DTS-HD High Resolution Audio as well as lossless formats Dolby TrueHD and DTS-HD Master Audio. BD audio content 250 may include one or more digital audio streams, languages, effects, channels, tracks, or the like. In general, audio, video and other streams can be multiplexed and stored on a Blu-ray Disc in a container format based on the MPEG transport stream, also known as as BDAV MPEG-2 transport stream (M2TS). Blu-ray Disc Video generally uses MPEG transport streams (TS), compared to DVD's MPEG program streams (PS). This may allow multiple video programs to be stored in the same file so they can be played back simultaneously.

BD interactive content 260 may include a wide variety of extra features in addition to BD video content 240 and BD audio content 250. BD interactive content 260 may also be stored on BD 220 separately from BD video content 240 and BD audio content 250. Interactive content can include audio commentary that is timed to a film sequence, documentary features, deleted scenes, photo galleries, storyboards, isolated music scores, trivia text commentary, games, film shorts, TV spots, radio spots and most commonly theatrical trailers, teaser trailers, or the like. Other extras that can be included BD 220 can include motion menus, still pictures, selectable subtitles, seamless branching for multiple storylines, camera angles, and BD-ROM/data files that can be accessed on a computer equipped with a BD-ROM capable drive.

The BD-ROM specification defines at least four Blu-ray Disc player profiles, including an audio-only player profile (i.e., BD-Audio) that does not require video decoding or BD-J. Any video-based player profiles (e.g., BD-Video) are required to have a full implementation of BD-J, with varying levels of hardware support. The BD-Live profile requires a Blu-ray Disc player to have an Internet connection to access Internet-based content. BD-Live features have included Internet chats, scheduled chats with the director, Internet games, downloadable featurettes, downloadable quizzes, and downloadable movie trailers. BD-Live may require local storage in order to handle additional content.

BD authored content 230 may include software. BD player 210 may include Sun Microsystems' JAVA cross-platform software environment. JAVA may be used to implement interactive menus on Blu-ray Discs, games, extra features, or the like. BD player 210 may include a JAVA Virtual Machine. The virtual machine may provide network connectivity, allowing updates via the Internet, adding of content such as additional subtitle languages and promotional features not included on the disc at pressing time, or the like. A version of JAVA called BD-J may be included that provides a subset of the Globally Executable Multimedia Home Platform (GEM) standard. BD-J, or Blu-ray Disc Java, provides a specification supporting Java ME Xlets for advanced content on Blu-ray Disc and the Packaged Media profile of GEM. An Xlet is very similar to a Java applet and is designed to support applications for Digital TV as part of Sun's JAVA TV specification. Xlets can be paused and resumed.

In various embodiments, BD-J Xlets provided one or more of the following capabilities. The invocation of BD-J Xlets may be triggered by events occurring around them—for example, by the selection of a movie title, or by the insertion of a new disc. Xlets in turn can then call other Xlets into play. Security in BDJ may be based on the Java platform security model. Signed applications in JARs can perform more tasks than a non-signed, such as Read/Write access to local storage, network access, selection of other titles on the BD-ROM disc, and control of other running BD-J applications. BD-J has classes that allow synchronization to specific frames in the movie. A BD-J application's GUI can be operated with a remote control with a required set of keys and an optional pointing device. The set of required keys includes at least the keys needed to support the User Operations in HDMV applications. The GUI framework in BD-J includes the HAVi(6) UI framework mandated by GEM. The GUI framework is based on the core of AWT as specified by PBP, but the widget set includes mechanisms for remote control navigation from GEM and easy customization of look and feel from HAVi.

BD-J can include a media framework similar to JMF for the playback of media content related to the BD-ROM disc. The BD-ROM disc may be the prime source for media files, but other sources could be a studio's web server and local storage. BD-J can include standard Java libraries for decoding and displaying images in JFIF (JPEG), PNG and other image formats. These images can be displayed on the Java graphics plane using standard Java graphics functions. An image can also be rendered in the background plane using a BD-J specific package. Text can be rendered using standard Java text functions. These text-rendering functions can be extended with a more advanced text layout manager that integrates with the BD-J UI framework. The text may be rendered using a vector-based font either coming from the disc, the player (default font) or downloaded from the network.

Authenticated applications can use a (signed) permission request file to acquire permissions that go beyond a BD-J sandbox. Permissions can be acquired for: reading and writing to local and system storage; using the network connection (to connect to defined servers); access of the file system on the BD-ROM disc; title selection of other titles on the BD-ROM disc; control of other running BD-J applications; or the like. BD-J applications can use the java.net package to connect to servers on the Internet. Moreover, a Java package for secure connections may be included (JSSE) as part of the BD-J platform. BD-J can also include support for storage.

In various embodiments, DVD authored content 130 may be included on BD 220 allowing any movie experience, high definition video, high quality sound, and/or interactivity provided by DVD authored content 130 to be accessed via BD player 210. In one embodiment, DVD authored content 130 may be stored as-is on a Blu-ray Disc for playback on BD player 210 without the need for further remastering. BD player 210 can be configured to interpret DVD navigations information in DVD authored content 130 and/or reformat audio/video information in DVD authored content 130 allowing any movie experience, high definition video, high quality sound, and/or interactivity provided by DVD authored content 130 to be experienced by users of BD player 220.

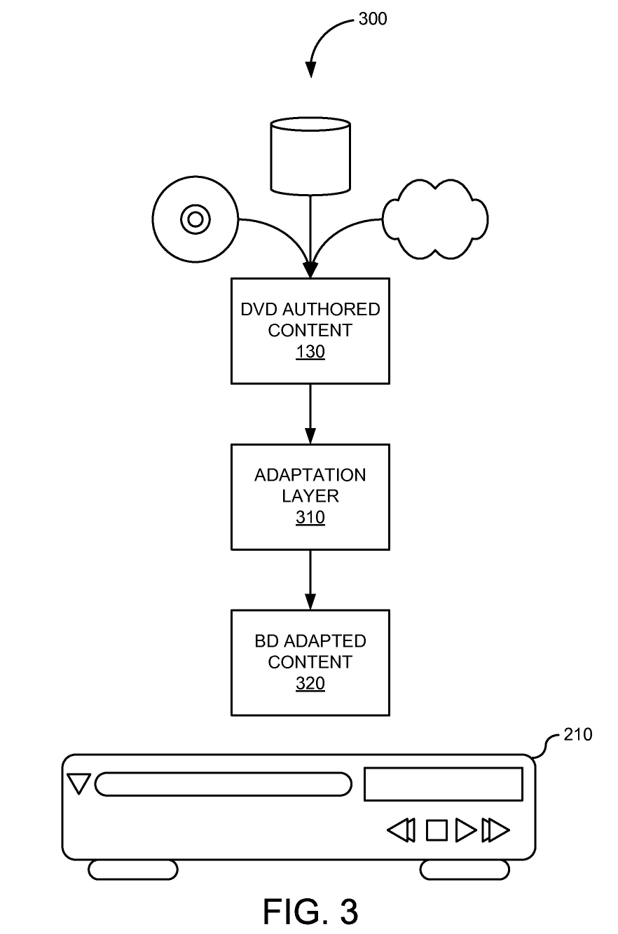

FIG. 3 is a block diagram illustrating playback using system 200 of FIG. 2 of DVD authored content stored on BD 220 in one embodiment according to the present invention. In some embodiments, adaptation layer 310 may be provided enabling access to DVD authored content delivered via Blu-ray Discs, storage device devices, or communications networks. Adaptation layer 310 can include hardware and/or software elements configured for adapting DVD authored content stored on a Blu-ray Disc into a format suitable for use by a Blu-ray Disc player. Adapting the content into a format suitable for use may include interpreting menus, hierarchies, data structures, or the like, converting, transcoding, or reformatting video streams, audio streams, subtitles, subpicutures, or the like, or preparing games, interactive features, extra, or the like for use by the Blu-ray player.

For example, in one embodiment, adaptation layer 310 may be embodied as a BD-J application. Adaptation layer 310 may be stored on BD 220 along with DVD authored content 130. Adaptation layer 310 can be configured to interpret DVD navigation information for BD player 210 for one or more standard definition DVDs stored on BD 220. Adaptation layer 310 may convert video and audio information in DVD authored content 120 into Blu-ray format (e.g., BD adapted content 320) for playback using the BD player 210.

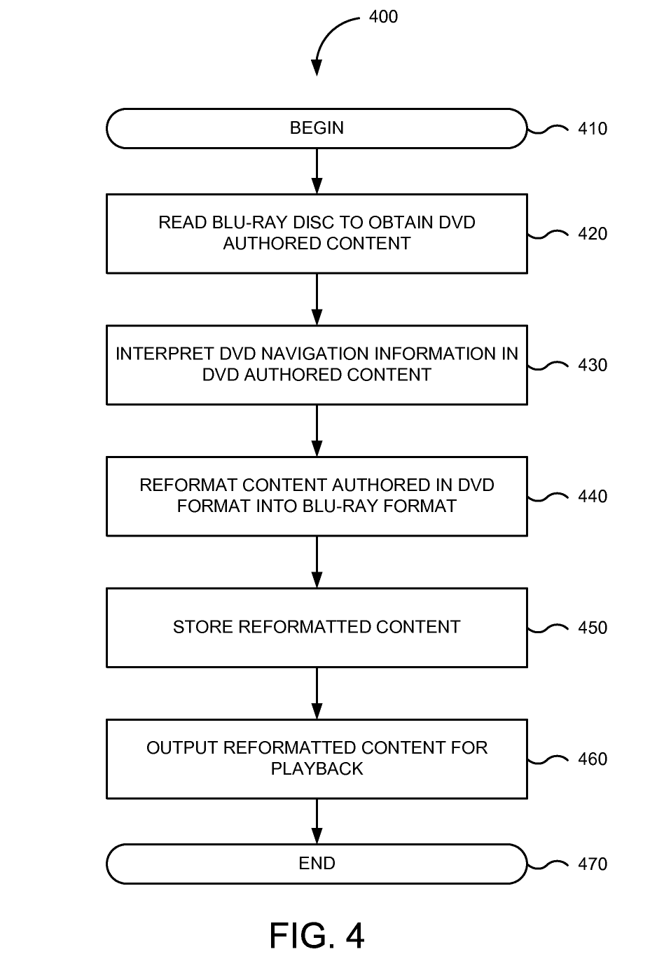

FIG. 4 is a flowchart of method 400 for playback using a Blu-ray Disc player of DVD authored content stored on a Blu-ray Disc in one embodiment according to the present invention. The processing of method 400 depicted in FIG. 4 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 400 depicted in FIG. 4 begins in step 410.

In step 420, a Blu-ray Disc is read to obtain DVD authored content. For example, BD player 210 may read BD 220 for information. The read information may include a portion of DVD authored content 130, such as menu information, navigation information, video streams, audio streams, or the like. BD player 210 may read BD 220 automatically, such as when BD 220 is first inserted into BD player 210. BD player 210 may read BD 220 in response to user input. BD player 210 may also read BD 220 in response to adaptation layer 310.

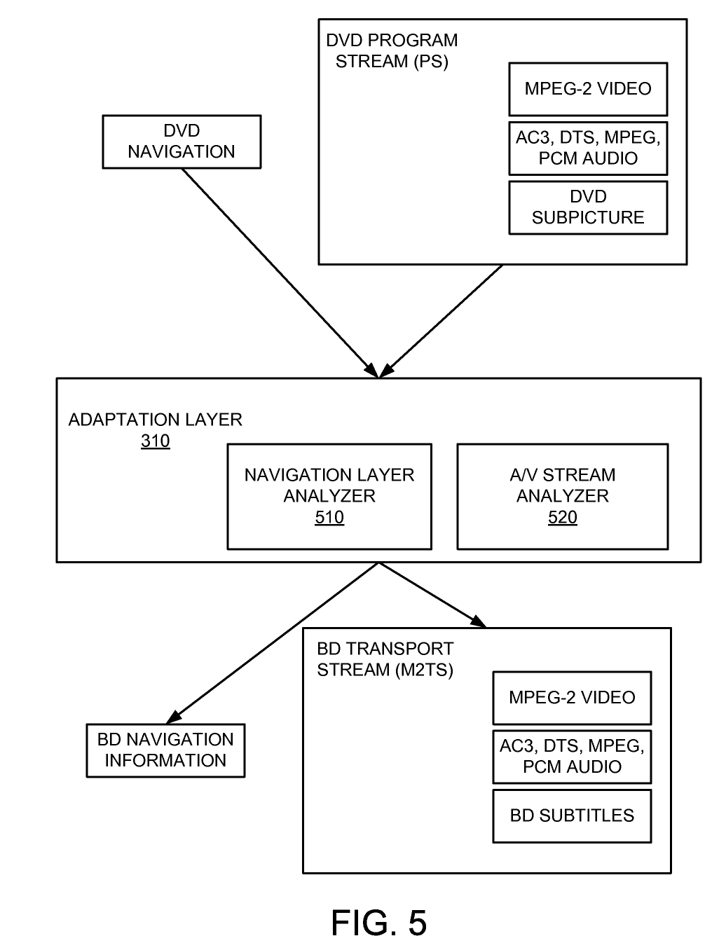

In step 430, DVD navigation information in the DVD authored content read from the Blu-ray Disc is interpreted. For example, BD player 210 may invoke adaptation layer 310 to interpret the DVD navigation information in the DVD authored content read from the Blu-ray Disc. As shown in FIG. 5, adaptation layer 310 may include navigation layer analyzer 510. Navigation layer analyzer 510 can include hardware and/or software elements configured for receiving DVD navigation information, interpreting menus, links, chapter selections, or the like in the DVD navigation information, and causing a Blu-ray Disc player to navigate to or otherwise cause selection of menus, links, chapter selections, or the like in the DVD navigation information. As shown in FIG. 5, adaptation layer 310 may control content navigation or otherwise output BD navigation information based on the DVD navigation information.

In step 440 of FIG. 4, content authored in DVD format is reformatted into Blu-ray format. For example, BD player 210 may invoke adaptation layer 310 to reformat or otherwise adapt the content authored in DVD format to be output from BD player 210. As shown in FIG. 5, adaptation layer 310 may include a/v stream analyzer 520. A/v stream analyzer 520 can include hardware and/or software elements configured for receiving DVD authored content, adapting the DVD authored content to a format suitable for a Blu-ray Disc player, and causing the Blu-ray Disc player to read, output, or otherwise interact with the adapted content.

In general, standard definition DVD may use Video Object (VOB) packetizing which transports MPEG2 Program Stream A/V data. Video can be encoded as standard definition (SD) MPEG-2. Audio can be encoded as Dolby AC3, MPEG, DTS, or plain PCM. Blu-ray Disc format may use MPEG-2 Transport Stream.

In one embodiment, adaptation layer 310 may demultiplex VOB data from DVD authored content stored on a Blu-ray Disc (e.g., a stored DVD) into raw audio/video elementary streams. This may occur in real-time or during an offline process. Adaptation layer 310 then may remultiplex the A/V streams into a MPEG-2 Transport Stream (M2TS). As shown in FIG. 5, trans-muxing by adaptation layer 310 may maintain audio and video elementary streams as is, where the original codec used provides the desired quality. Adaptation layer 310 converts the content transport container from Program Stream (PS for DVDs) into M2TS for BD. Adaptation layer 310 may transcode subtitles from DVD subpicture format into BD subtitles or any BD compatible format.

In one embodiment, adaptation layer 310 may transcode video from standard definition (SD) to high definition (HD) using one or more techniques for up-scaling. The up-scaling may be achieved by adaptation layer 310 invoking features of a Blu-ray Disc player itself, using one or more offline tools or techniques, in real-time, or the like. Adaptation layer 310 may include offline tools for up-scaling that provide one or more advantages. For example, quality can be substantially consistent across all players (e.g., quality is not dependent on a player's up-scaling algorithm implementation). Additionally, quality can be fine-tuned for the type of material (vs. one size fits all approach) and have several pass algorithm providing the best quality.

Adaptation layer 310 may incorporate other steps in an A/V transformation. These may include MPEG-2 (A/V) DVD SD transcode and remux to AVC (H.264 and VC1) SD. These may also include MPEG-2 (A/V) DVD ES decoding and format conversion to HD Base band (e.g., all acceptable BD resolutions). These may also include transcode and Remux AVC (HD H.264 L4.1 and VC1 level 3) and audio transcode optional from MPEG2 L1 or Dolby AC3 to Dolby Plus or other BD advanced audio formats.

Generally, the DVD format allows a limited number of colors for buttons and subtitles. Accordingly, adaptation layer 310 may incorporate dithering to allow for more colors. In one embodiment, during the conversion to BD format, adaptation layer 310 may employ a 32 bit gradient to provide enhanced colors for displayed elements.

In some embodiments, Adaptation layer 310 may analyze and parse subtitles so that a textual representation is extracted. The text representation may be used to perform searches and generate new more pleasant hi-res subtitles. Additionally, subtitles contrast may be enhanced so that they are well contrasted with the currently displayed video.

Returning to FIG. 4, in step 450, the reformatted content is stored. Storage may occur in a temporary memory buffer used by BD player 210 to output the reformatted content. Storage may also occur in volatile or non-volatile memories. As discussed above, adaptation or reformatting may be an offline process where the reformatted content is stored for subsequent retrieval and use. In step 460, the reformatted content is output for playback. Playback may include the outputting of video, audio, images, interactive games, navigation menus, or the like. FIG. 4 ends in step 470.

In various embodiments, as several DVDs may be bundled into a single BD, an additional hierarchy may be created to introduce the concept of root navigation. Such a hierarchy can be introduced to provide hierarchical access to each of the stored DVDs starting from a root menu.

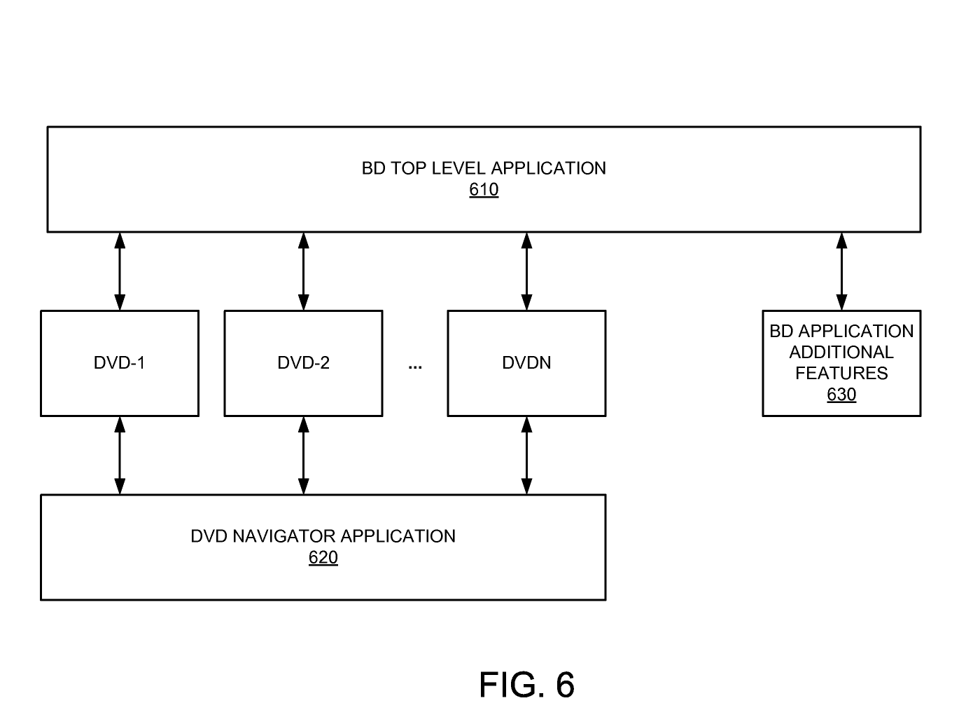

FIG. 6 is a block diagram illustrating navigation using BD player 210 of multiple DVDs stored on BD 220 in one embodiment according to the present invention. In various embodiments, each DVD maintains its own navigation menu, as it was on standard definition DVD. Some examples of use may include bundling one or several SD DVDs into a single Blu-ray format for content owners, or converting home videos onto Blu-ray disc.

A DVD navigator virtual machine (e.g., DVD navigator application 620) may be provided to handle this layer and ensure the compatibility with a BD-J Top Level Application 610. BD-J Top Level Application 610 may be embodied as adaptation layer 310. In further embodiments, BD-J Top Level Application 610 may provide access to BD advanced features (e.g., BD Application Additional Features 630). These may include features such as seamless menu loops and seamless audio switch. In addition to have a BD menu to access the regular DVDs, extra BD features can be added (e.g. games, featurettes, BD-Live applications). Some BD-J Application features that may be added automatically can include search in the subtitles, multiple subtitles at the same time, slow play with correct pitch, or the like.

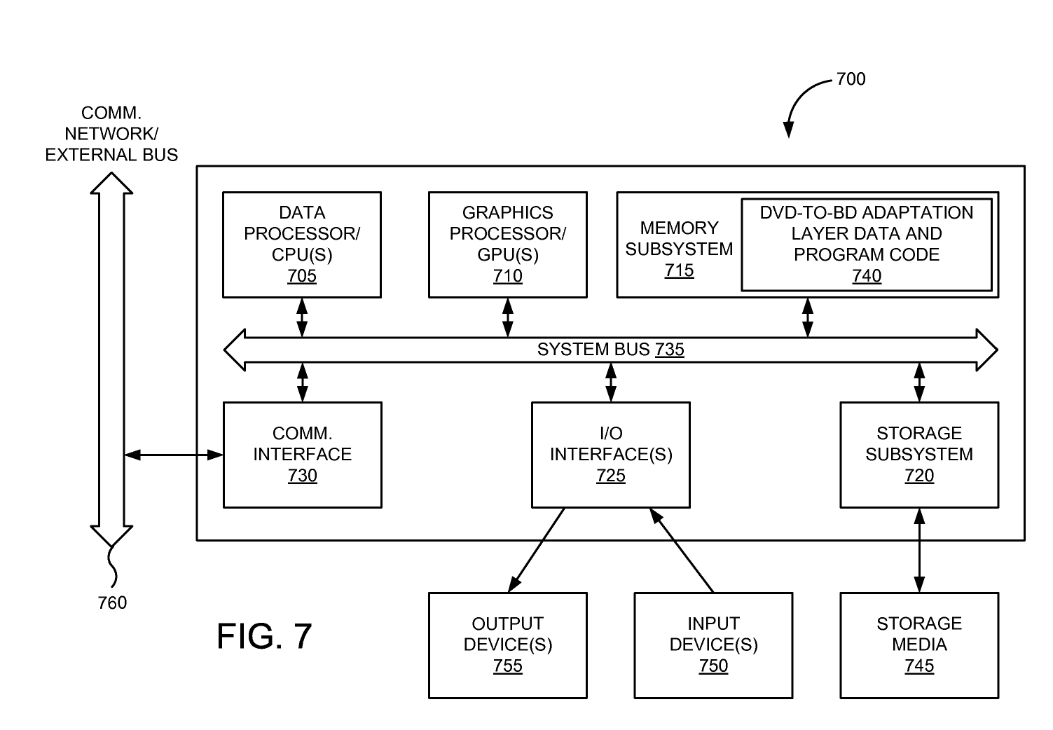

FIG. 7 is a block diagram of computer system 700 that may incorporate an embodiment, be incorporated into an embodiment, or be used to practice any of the innovations, embodiments, and/or examples found within this disclosure. FIG. 7 is merely illustrative of any computing device, general-purpose computer system programmed according to one or more disclosed techniques, specific information processing device programmed according to one or more disclosed techniques, or consumer electronic device configured for an embodiment incorporating an invention whose teachings may be presented herein and does not limit the scope of the invention as recited in the claims. One of ordinary skill in the art would recognize other variations, modifications, and alternatives.

Computer system 700 can include hardware and/or software elements configured for performing logic operations and calculations, input/output operations, machine communications, or the like. Computer system 700 may include familiar computer components, such as one or more one or more data processors or central processing units (CPUs) 705, one or more graphics processors or graphical processing units (GPUs) 710, memory subsystem 715, storage subsystem 720, one or more input/output (I/O) interfaces 725, communications interface 730, or the like. Computer system 700 can include system bus 735 interconnecting the above components and providing functionality, such connectivity and inter-device communication. Computer system 700 may be embodied as a computing device, such as a personal computer (PC), a workstation, a mini-computer, a mainframe, a cluster or farm of computing devices, a laptop, a notebook, a netbook, a PDA, a smartphone, a consumer electronic device, an optical disc player, a gaming console, or the like.

The one or more data processors or central processing units (CPUs) 705 can include hardware and/or software elements configured for executing logic or program code or for providing application-specific functionality. Some examples of CPU(s) 705 can include one or more microprocessors (e.g., single core and multi-core) or micro-controllers, such as PENTIUM, ITANIUM, or CORE 2 processors from Intel of Santa Clara, Calif. and ATHLON, ATHLON XP, and OPTERON processors from Advanced Micro Devices of Sunnyvale, Calif. CPU(s) 705 may also include one or more field-gate programmable arrays (FPGAs), application-specific integrated circuits (ASICs), or other microcontrollers. The one or more data processors or central processing units (CPUs) 705 may include any number of registers, logic units, arithmetic units, caches, memory interfaces, or the like. The one or more data processors or central processing units (CPUs) 705 may further be integrated, irremovably or moveably, into one or more motherboards or daughter boards.

The one or more graphics processor or graphical processing units (GPUs) 710 can include hardware and/or software elements configured for executing logic or program code associated with graphics or for providing graphics-specific functionality. GPUs 710 may include any conventional graphics processing unit, such as those provided by conventional video cards. Some examples of GPUs are commercially available from NVIDIA, ATI, and other vendors. In various embodiments, GPUs 710 may include one or more vector or parallel processing units. These GPUs may be user programmable, and include hardware elements for encoding/decoding specific types of data (e.g., video data) or for accelerating 2D or 3D drawing operations, texturing operations, shading operations, or the like. The one or more graphics processors or graphical processing units (GPUs) 710 may include any number of registers, logic units, arithmetic units, caches, memory interfaces, or the like. The one or more data processors or central processing units (CPUs) 705 may further be integrated, irremovably or moveably, into one or more motherboards or daughter boards that include dedicated video memories, frame buffers, or the like.

Memory subsystem 715 can include hardware and/or software elements configured for storing information. Memory subsystem 715 may store information using machine-readable articles, information storage devices, or computer-readable storage media. Some examples of these articles used by memory subsystem 770 can include random access memories (RAM), read-only-memories (ROMS), volatile memories, non-volatile memories, and other semiconductor memories. In various embodiments, memory subsystem 715 can include DVD-to-BD adaptation layer data and program code 740.

Storage subsystem 720 can include hardware and/or software elements configured for storing information. Storage subsystem 720 may store information using machine-readable articles, information storage devices, or computer-readable storage media. Storage subsystem 720 may store information using storage media 745. Some examples of storage media 745 used by storage subsystem 720 can include floppy disks, hard disks, optical storage media such as CD-ROMS, DVDs and bar codes, removable storage devices, networked storage devices, or the like. In some embodiments, all or part of DVD-to-BD adaptation layer data and program code 740 may be stored using storage subsystem 720.

In various embodiments, computer system 700 may include one or more hypervisors or operating systems, such as WINDOWS, WINDOWS NT, WINDOWS XP, VISTA, or the like from Microsoft or Redmond, Wash., SOLARIS from Sun Microsystems, LINUX, UNIX, and UNIX-based operating system. Computer system 700 may also include one or more applications configured to executed, perform, or otherwise implement techniques disclosed herein. These applications may be embodied as DVD-to-BD adaptation layer data and program code 740. Additionally, computer programs, executable computer code, human-readable source code, code engines, or the like, and data, such as files, models, procedural descriptions, descriptor files, or the like, may be stored in memory subsystem 715 and/or storage subsystem 720.

The one or more input/output (I/O) interfaces 725 can include hardware and/or software elements configured for performing I/O operations. One or more input devices 750 and/or one or more output devices 755 may be communicatively coupled to the one or more I/O interfaces 725.

The one or more input devices 750 can include hardware and/or software elements configured for receiving information from one or more sources for computer system 700. Some examples of the one or more input devices 750 may include a computer mouse, a trackball, a track pad, a joystick, a wireless remote, a drawing tablet, a voice command system, an eye tracking system, external storage systems, a monitor appropriately configured as a touch screen, a communications interface appropriately configured as a transceiver, or the like. In various embodiments, the one or more input devices 750 may allow a user of computer system 700 to interact with one or more non-graphical or graphical user interfaces to enter a comment, select objects, icons, text, user interface widgets, or other user interface elements that appear on a monitor/display device via a command, a click of a button, or the like.

The one or more output devices 755 can include hardware and/or software elements configured for outputting information to one or more destinations for computer system 700. Some examples of the one or more output devices 755 can include a printer, a fax, a feedback device for a mouse or joystick, external storage systems, a monitor or other display device, a communications interface appropriately configured as a transceiver, or the like. The one or more output devices 755 may allow a user of computer system 700 to view objects, icons, text, user interface widgets, or other user interface elements.

A display device or monitor may be used with computer system 700 and can include hardware and/or software elements configured for displaying information. Some examples include familiar display devices, such as a television monitor, a cathode ray tube (CRT), a liquid crystal display (LCD), or the like.

Communications interface 730 can include hardware and/or software elements configured for performing communications operations, including sending and receiving data. Some examples of communications interface 730 may include a network communications interface, an external bus interface, an Ethernet card, a modem (telephone, satellite, cable, ISDN), (asynchronous) digital subscriber line (DSL) unit, FireWire interface, USB interface, or the like. For example, communications interface 730 may be coupled to communications network/external bus 780, such as a computer network, to a FireWire bus, a USB hub, or the like. In other embodiments, communications interface 730 may be physically integrated as hardware on a motherboard or daughter board of computer system 700, may be implemented as a software program, or the like, or may be implemented as a combination thereof.

In various embodiments, computer system 700 may include software that enables communications over a network, such as a local area network or the Internet, using one or more communications protocols, such as the HTTP, TCP/IP, RTP/RTSP protocols, or the like. In some embodiments, other communications software and/or transfer protocols may also be used, for example IPX, UDP or the like, for communicating with hosts over the network or with a device directly connected to computer system 700.

As suggested, FIG. 7 is merely representative of a general-purpose computer system, specific-purpose computing device, or consumer electronic device, appropriately configured or capable of implementing or incorporating various embodiments of an invention presented within this disclosure. Many other hardware and/or software configurations may be apparent to the skilled artisan which are suitable for use in implementing an invention presented within this disclosure or with various embodiments of an invention presented within this disclosure. For example, a computer system or data processing device may include desktop, portable, rack-mounted, or tablet configurations. Additionally, a computer system or information processing device may include a series of networked computers or clusters/grids of parallel processing devices. In still other embodiments, a computer system or information processing device may techniques described above as implemented upon a chip or an auxiliary processing board.

Various embodiments of any of one or more inventions whose teachings may be presented within this disclosure can be implemented in the form of logic in software, firmware, hardware, or a combination thereof. The logic may be stored in or on a machine-accessible memory, a machine-readable article, a tangible computer-readable medium, a computer-readable storage medium, or other computer/machine-readable media as a set of instructions adapted to direct a central processing unit (CPU or processor) of a logic machine to perform a set of steps that may be disclosed in various embodiments of an invention presented within this disclosure. The logic may form part of a software program or computer program product as code modules become operational with a processor of a computer system or an information-processing device when executed to perform a method or process in various embodiments of an invention presented within this disclosure. Based on this disclosure and the teachings provided herein, a person of ordinary skill in the art will appreciate other ways, variations, modifications, alternatives, and/or methods for implementing in software, firmware, hardware, or combinations thereof any of the disclosed operations or functionalities of various embodiments of one or more of the presented inventions.

The disclosed examples, implementations, and various embodiments of any one of those inventions whose teachings may be presented within this disclosure are merely illustrative to convey with reasonable clarity to those skilled in the art the teachings of this disclosure. As these implementations and embodiments may be described with reference to exemplary illustrations or specific figures, various modifications or adaptations of the methods and/or specific structures described can become apparent to those skilled in the art. All such modifications, adaptations, or variations that rely upon this disclosure and these teachings found herein, and through which the teachings have advanced the art, are to be considered within the scope of the one or more inventions whose teachings may be presented within this disclosure. Hence, the present descriptions and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

What is claimed is:

1. A method for playback of Digital Versatile Disc (DVD) authored content stored on Blu-ray Discs, the method comprising:
receiving content authored in the DVD format at a first application hosted by a processor associated with a Blu-ray Disc player in information read from a Blu-ray Disc by the Blu-ray Disc player;
reformatting the content authored in the DVD format with the first application into the Blu-ray format; and
storing the content in the Blu-ray format in a storage device associated with the Blu-ray Disc player.

2. The method of claim 1 wherein receiving the content authored in the DVD format at the first application comprises receiving a Video Object (VOB) file.

3. The method of claim 1 wherein receiving the content authored in the DVD format at the first application comprises receiving video information or audio information in a Moving Pictures Expert Group Program Stream (MPEG-PS).

4. The method of claim 1 wherein receiving the content authored in the DVD format at the first application comprises receiving DVD navigation information.

5. The method of claim 4 further comprising interpreting the DVD navigation information with the first application hosted by the processor associated with the Blu-ray Disc player to navigate the content authored in the DVD format.

6. The method of claim 1 wherein reformatting the content authored in the DVD format with the first application into the Blu-ray format comprises reformatting the content authored in the DVD format into a Moving Pictures Expert Group (MPEG)-2 transport stream (M2TS).

7. The method of claim 1 wherein reformatting the content authored in the DVD format with the first application into the Blu-ray format comprises:
demultiplexing the DVD authored content into one or more video streams and one or more audio streams; and
remultiplexing the one or more video streams and the one or more audio streams into the Blu-ray format.

8. The method of claim 1 wherein reformatting the content authored in the DVD format with the first application into the Blu-ray format comprises transcoding audio or video information associated with the DVD format to the Blu-ray format.

9. The method of claim 1 further comprising:
receiving, at a second application hosted by the processor associated with the Blu-ray Disc player, navigation information associated with a plurality of DVDs stored on the Blu-ray Disc; and
reading the information from the Blu-ray Disc by the Blu-ray Disc player in response to navigating to at least one of the plurality of DVDs stored on the Blu-ray Disc with the second application based on the navigation information.

10. The method of claim 1 wherein the first application comprises a Blu-ray Disc JAVA (BD-J) application.

11. A consumer electronic device configured as the Blu-ray Disc player for implementing the method of claim 1.

12. A personal computer system configured as the Blu-ray Disc player for implementing the method of claim 1.

13. An information storage medium storing instructions executable by Blu-ray Disc players for playback of Digital Versatile Disc (DVD) authored content stored on Blu-ray Discs, the information storage medium comprising:
instructions for receiving content authored in the DVD format in information read from a Blu-ray Disc by a Blu-ray Disc player;
instructions for reformatting the content authored in the DVD format into the Blu-ray format; and
instructions for storing the content in the Blu-ray format in a storage device associated with the Blu-ray Disc player.

14. The information storage medium of claim 13 wherein the instructions for receiving the content authored in the DVD format comprise instructions for receiving a Video Object (VOB) file.

15. The information storage medium of claim 13 wherein the instructions for receiving the content authored in the DVD format comprise instructions for receiving video information or audio information in a Moving Pictures Expert Group Program Stream (MPEG-PS).

16. The information storage medium of claim 13 wherein the instructions for receiving the content authored in the DVD format comprise instructions for receiving DVD navigation information.

17. The information storage medium of claim 16 further comprising instructions for interpreting the DVD navigation information to navigate the content authored in the DVD format.

18. The information storage medium of claim 13 wherein the instructions for reformatting the content authored in the DVD format into the Blu-ray format comprise instructions for reformatting the content authored in the DVD format into a Moving Pictures Expert Group (MPEG)-2 transport stream (M2TS).

19. The information storage medium of claim 13 wherein the instructions for reformatting the content authored in the DVD format into the Blu-ray format comprise:
instructions for demultiplexing the DVD authored content into one or more video streams and one or more audio streams; and
instructions for remultiplexing the one or more video streams and the one or more audio streams into the Blu-ray format.

20. The information storage medium of claim 13 wherein the instructions for reformatting the content authored in the DVD format into the Blu-ray format comprise instructions for transcoding audio or video information associated with the DVD format to the Blu-ray format.

21. The information storage medium of claim 13 further comprising:
instructions for receiving navigation information associated with a plurality of DVDs stored on the Blu-ray Disc; and
instructions for reading the information from the Blu-ray Disc by the Blu-ray Disc player in response to navigating to at least one of the plurality of DVDs stored on the Blu-ray Disc based on the navigation information.
